(19) United States
(12) Patent Application Publication
(10) Pub. No.: US 2018/0148388 A1
(43) Pub. Date: May 31, 2018

(54) Preparation and usage method of dried rehmannia roots regulatory element

(71) Applicants: Yuanhui Fu, Chino Hills, CA (US); Jiaqi Chai, Chino Hills, CA (US)

(72) Inventors: Yuanhui Fu, Chino Hills, CA (US); Jiaqi Chai, Chino Hills, CA (US)

(21) Appl. No.: 15/361,535

(22) Filed: Nov. 28, 2016

(51) Int. Cl. C05F 1/00; C05F 17/00

(52) U.S. Cl. CPC C05F 1/005; C05F 17/00

(57) ABSTRACT

A preparation and usage method of dried rehmannia root regulatory element comprising: wrap the chrysanthemums deprived of partial water with an animal intestine membrane; place the wrapped dried rehmannia roots into soil and dig it out after a winter; store it into a gallipot and leave it in a shaded place; grind it into powders; mix it with water and spray it around plant roots.

### TECHNICAL FIELD

This invention is about soil and plant nutrition preparation technique, specifically, Preparation and Usage Method of Dried Rehmannia Roots Regulatory Element.

### BACKGROUND OF THE INVENTION

At this time, the agriculture industry still mainly uses chemical fertilizers to improve plants production volume. But due to an excessive usage of chemical fertilizers, the productivity of soil is declining. Seen from people's health perspective, the agricultural products grown due to a usage of chemical fertilizers are less and less favorable.

This invention is based on biodynamic basis and the regulatory element is made of all natural materials turned into fertilizer through fermentation. This type of invention has been long proved to be reliable and is deemed as having met the top standards of biodynamic agriculture.

### DESCRIPTION

this invention pertains to a preparation and usage of dried rehmannia roots regulatory element, which will help plants grow without harmful consequences.

This invention is processed and completed in the following ways:

Use animal intestine membrane wrapper for dried rehmannia roots that have been rid off partial water; Put the wrapped dried rehmannia roots into soil and keep it there for a winter; Dig out the wrapped dried rehmannia roots and put them into a gallipot container and store the container in a shaded place.

Further, the said animal intestine membrane is cow intestine membrane.

Further, the said dried rehmannia roots are product of organic planting.

Further, the said dried rehmannia roots with partial water are ones deprived of 30%-70% of the original water from the dried rehmannia roots.

Further, the step of a burial of the wrapped dried rehmannia roots into soil over a winter can also be substituted with a process conducted inside a room with controlled temperatures: the whole process is divided into four stages: 1). The room temperature is set between 15-20° C. and this stage is two month long; 2). The second stage is to control the room temperature between 0-15° C. for a time of 2 months; 3). The temperature is controlled at −30-0° C. for the length of one month; 4). The storage temperature is maintained between 0-10° C. for two months long.

This invention also publicizes a dried rehmannia roots regulatory element produced according to the above methods.

This invention also publicizes the usage methods of the dried rehmannia roots regulatory element, which includes the following steps:

1). Grind the wrapped dried rehmannia roots into powders;

2). Mix the powders with water (purified, distilled, or rain) with ratio 0.1-0.2 g/L;

3). Stir the powders evenly and then spray it around plant roots at a ratio 35-60 L/666.67 square meters.

Further, the water for the powders mixture is rain water, purified water or distilled water.

Further, the usage method also includes an even stirring of the said regulatory element.

Further, the stirring speed of the said regulatory element is 50-120 r/min, and alter the stirring direction every 0.5-5 min.; the length of stirring time is between 60-70 min.

The benefits of this invention are to improve soil fertilization and spur the growth of plants without harmful side effects.

The embodiments of the invention in which an exclusive property or privilege is claimed are defined as follows:

1. A preparation of dried rehmannia roots regulatory element comprising: use animal intestine membrane to wrap dried rehmannia roots that are deprived of partial water and then bury it into soil and then dig it out after a winter, store it in a gallipot and place it in a shaded place.

2. A usage method of the dried rehmannia roots regulatory element recited in claim 1 is characterized by the following steps: grind the wrapped dried rehmannia roots into powders; mix the powders with water (purified, distilled, or rain) with ratio 0.1-0.2 g/L; stir the mixture evenly and spray it around plant roots at a ratio 35-60 L/666.67 square meters.
